(19) United States
(12) Patent Application Publication
(10) Pub. No.: US 2014/0040859 A1
(43) Pub. Date: Feb. 6, 2014

(54) Generating and Presenting Property Editors

(71) Applicant: Narciso Jaramillo, Oakland, CA (US)

(72) Inventor: Narciso Jaramillo, Oakland, CA (US)

(73) Assignee: ADOBE SYSTEMS INCORPORATED, San Jose, CA (US)

(21) Appl. No.: 11/777,982

(22) Filed: Jul. 13, 2007

(51) Int. Cl. G06F 9/44

(52) U.S. Cl. 717/113

(57) ABSTRACT

Various aspects can be implemented to generate property editors for configuring visual objects, such as user interfaces and complex graphical objects, and present the property editors with visual indicators linking to the visual object. In general, one aspect of the subject matter described in this specification can be embodied in a method that includes receiving user input to access a property editor associated with at least one feature of a visual object. The method also includes dynamically generating the property editor in response to the user input. The method further includes presenting the visual object and the property editor on a display screen along with a visual indicator linking at least one aspect of the property editor to the at least one feature of the visual object. Other embodiments of this aspect include corresponding systems, apparatus, and computer program products.

### BACKGROUND

The present disclosure relates to generating and presenting property editors for configuring visual objects, such as user interfaces and complex graphical objects.

Visual objects, such as graphical user interfaces, can be authored and configured in a design tool. In design tools, configuring visual properties of visual objects is typically done through an interface outside of the design view itself. For example, a modal dialog box, a toolbar, or a modeless palette or property inspector is typically used. A graphical user interface can have various components, such as text fields, data tables, sliders, panels, buttons, menus and the like. Each component can have various features, such as header, border, shadow, background, corner and the like. Additionally, each feature of a component of a graphical user interface can have various visual properties, such as font, color, and size of the text, corner radius, shadow distance and the like. As a result, the design tool typically provides a large number of controls for configuring visual objects.

### SUMMARY

This specification describes technologies that relate to generating property editors for configuring visual objects, such as user interfaces and complex graphical objects, and presenting visual indicators linking the property editors to the visual objects. In general, one aspect of the subject matter described in this specification can be embodied in a method that includes receiving user input to access a property editor associated with at least one feature of a visual object. The method also includes dynamically generating the property editor in response to the user input. The method further includes presenting the visual object and the property editor on a display screen along with a visual indicator linking at least one aspect of the property editor to the at least one feature of the visual object. Other embodiments of this aspect include corresponding systems, apparatus, and computer program products.

Another aspect of the subject matter described in this specification can be embodied in a method that includes receiving user input to access a property editor associated with at least one feature of a visual object. The property editors may not be dynamically generated in response to the user input. The method also includes presenting the visual object and the property editor on a display screen along with a visual indicator linking at least one aspect of the property editor to the at least one feature of the visual object. Other embodiments of this aspect include corresponding systems, apparatus, and computer program products.

Yet another aspect of the subject matter described in this specification can be embodied in a system that includes a user interface device; and one or more computers operable to perform operations that include receiving user input to access a property editor associated with at least one feature of a visual object. The operations also includes dynamically generating the property editor in response to the user input. The operations further include presenting the visual object and the property editor on a display screen along with a visual indicator linking at least one aspect of the property editor to the at least one feature of the visual object.

These and other embodiments can optionally include one or more of the following features. The method can include dynamically generating a plurality of additional property editors in response to the user input, the plurality of additional property editors being associated with a plurality of additional features of the visual object. The method can also include presenting the visual object and the plurality of additional property editors on a display screen along with a visual indicator linking each of the plurality of property editors to at least one of the plurality of features of the visual object. The method can further include obtaining the visual object in an authoring tool.

The act of presenting the visual object and the property editor on the display screen can include automatically repositioning a design view of the visual object on the display screen to make room for the property editor on the display screen. The act of presenting the visual object and the property editor on the display screen can also include automatically focusing on the visual object by fading out other objects on the display screen. The act of presenting the visual object and the property editor on the display screen can further include automatically repositioning the property editor in response to a change in size or position of the visual object on the display screen.

The user input can include one or more of the following: pressing a hot key, selecting an edit tool from a menu, or selecting the visual object. Additionally, the user input can be used to select the visual object or select an individual feature of the visual object. In this manner, if the entire visual object is selected, all of the property editors associated with the visual object can be presented. If the individual feature of the visual object is selected, however, only the property editors associated with the selected feature will be presented. The visual object can include a component of a user interface. The at least one feature can be a feature of the component of the user interface selected from a group including a header, a button, a border, a shadow, a text of the header, and a corner.

The property editor can be displayed proximate to but out of the way of (e.g., without obscuring) the visual object. The at least one feature can include at least one visual property for a graphics object configurable through the property editor. The at least one visual property can include one or more of the following: color, font, text alignment, size, layout, and opacity. The method can further include receiving a second user input to modify the at least one visual property through the property editor. The method can additionally include presenting a modified feature in response to the second user input and based on the modified visual property. The visual indicator can be any graphics indicator, such as a straight line, a dashed line, a curved line, or an arrow.

The one or more computers can include a server operable to interact with the user interface device through a data communication network, and the user interface device can be operable to interact with the server as a client. The user interface device can include a computer running a Web browser, a mobile telephone running a wireless application protocol (WAP) browser, or a personal digital assistant (PDA) running a WAP browser. Moreover, the one or more computers can include one personal computer, and the personal computer can include the user interface device.

Particular embodiments of the subject matter described in this specification can be implemented to realize one or more of the following advantages. An in-place (e.g., displayed simultaneously in the same design view or display screen) way to configure visual properties of a visual object can be provided that makes it clearer and more intuitive to a user how the individual controls of the property editors relate to the actual appearance of the object. Property sheets or palettes that are disconnected from the object being configured in a design view can be avoided. Visual indicators can allow the user to see directly which controls of the property editors affect which features and visual properties of the component, and long labels or multiple individual icons for the controls can also be avoided.

Additionally, controls associated with a single feature can be logically grouped together. For example, controls for editing the font, size, and color of the text can be logically grouped together as a control group in one in-place property editor. Because property editors can appear proximate to but out of the way of (e.g., without obscuring) the visual object and visually indicate which features of the object the property editor refers to, visual objects can be configured easily and efficiently in an authoring environment. Additionally, a feature of the visual object can be modified without the user knowing how a particular control affects the feature of the visual object. For example, a user may not know that the controls for “shadow” refers to the border of a panel component of a UI; however, the in-place property editors can allow a user to intuitively and quickly configure the border using controls for “shadow” because of the visual indicators.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 shows a design tool that dynamically generates and presents property editors for configuring a visual object.

FIG. 2 is a flow chart showing an example process of providing property editors for configuring a visual object in a design tool.

FIG. 3 is a flow chart showing an example process of generating property editors associated with a visual object.

FIG. 4 is a flow chart showing an example process of presenting property editors associated with a visual object.

FIG. 5 shows example design views illustrating property editors associated with a visual object.

FIG. 6 shows an example system configured to dynamically generate and present property editors associated with a visual object.

Like reference numbers and designations in the various drawings indicate like elements.

### DETAILED DESCRIPTION

The systems and techniques described here relate to providing one or more property editors for configuring a visual object in response to user requests in a design tool. The property editors are presented in a design view or display screen in ways that allow the users to intuitively and immediately recognize how the individual controls of the property editors relate to the various features of the visual object. In particular, a user can provide input (e.g., by pressing a hot key or selecting the object) to bring up the property editors for a given visual object. The property editors can appear as a set of decorations around the selected object. Representations of properties can be shown around the object itself, pointing to the features of the object they affect. In this manner, the need for long labels or multiple individual icons can be avoided because the user can see directly which controls affect which features of the object, and property controls associated with a single feature can be logically grouped together as a control group.

In the examples described in this disclosure, the techniques relate to providing in-place property editors for a UI design tool. When the user selects an object of a UI (or explicitly requests the property editor), a property editor layout specific to the type of the selected object can be dynamically generated and presented simultaneously with the selected object in the design view. Individual controls in a property editor can be positioned relative to the corresponding feature of the selected object. For example, a control in the property editor relevant to the border of the object can be placed on one side of the object, and a visual indicator (e.g., a line) can be drawn from the control to the border. In this manner, visual indicators can link individual controls in the property editor to the appropriate corresponding features of the selected object.

Additionally, if the user moves the visual object or changes its size (e.g., by changing a property or directly manipulating the object) in the design view, the property editor can adjust its layout by automatically repositioning itself to keep in sync with the size and position of the object. Alternatively, if there is no room on one or more sides of the selected object for the presentation of the property editor, the design view can automatically reposition the object (e.g., by auto-scrolling the design view in order to move the visual object out of the way) to make room for the property editor. In this manner, the property editors do not obscure relevant features of the visual object and both the visual object and property editors can be displayed simultaneously in the design view.

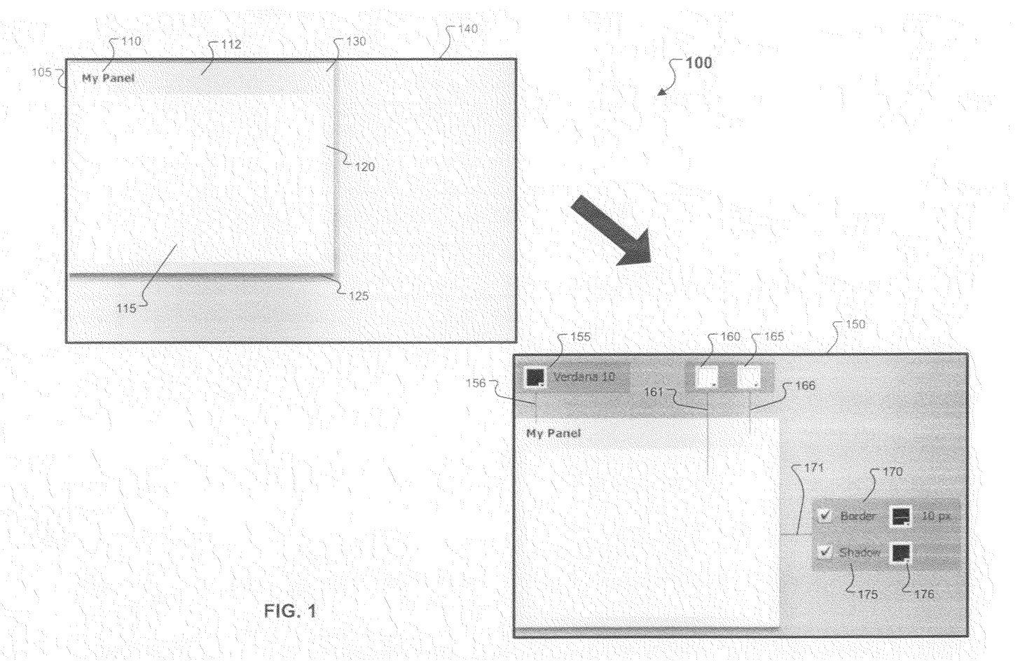

FIG. 1 shows a design tool 100 that provides in-place property editors for configuring a visual object 105 in a design tool. The design tool 100 and its associated methods can allow users to configure the visual object 105 through the in-place property editors 155, 160, 165, 170, and 175, which are presented simultaneously with the object 105. In general, the visual object 105 can be any object in a design tool with a complex appearance and based on many different visual properties. For example, the visual object 105 can be one of various components of a UI or it can be a complex graphical object. As shown in FIG. 1, the first display screen 140 depicts the visual object 105 as a panel component of a UI. However, in-place property editors can also be provided for other components of a UI, such as button, scroll bar, menu, and navigator components.

The visual object 105 includes various features associated with the panel component. For example, feature 110 is associated with the text of the header, feature 112 is associated with the header of the panel, feature 115 is associated with the content and the background of the panel, feature 120 is associated with the border of the panel, feature 125 is associated with the shadow of the panel, and feature 130 is associated with the corner of the panel. As noted above, design tool 100 can provide in-place property editors in response to user input for configuring style properties associated with these various features of the visual object 105.

For example, when a user selects the visual object 105 in the design tool (e.g., by clicking on the object), design tool 100 can automatically generate in-place editors as shown in the second display screen 150. In one implementation, the dynamically generated in-place property editors can include property editors 155, 160, 165, 170, and 175. Property editor 155 is associated with feature 110 (e.g., the text of the header); property editor 160 is associated with feature 115 (e.g., the background of the panel); property editor 165 is associated with feature 112 (e.g., the header of the panel); property editor 170 is associated with feature 120 (e.g., the border of the panel); and property editor 175 is associated with feature 125 (e.g., the shadow of the panel).

Additionally, the second display screen 150 includes various visual indicators (which are represented by straight lines) linking the property editors with their associated or corresponding features of the visual object 105. For example, visual indicator 156 visually connects property editor 155 with its corresponding feature 110. In this manner, a user of the design tool can easily and immediately recognize that property editor 155 can be used to edit or modify the visual properties of feature 110. For example, by selecting property editor 155 a user can change the font, the text size, and/or the color of feature 110. Additionally, visual indicator 161 is shown to visually link property editor 160 with its corresponding feature 115, and visual indicator 166 is shown to visually link property editor 165 with its corresponding feature 112. Furthermore, visual indicator 171 is shown to visually link property editors 170 and 175 with their corresponding features 120 and 125.

In the examples shown in FIG. 1, the visual indicators 156, 161, 166, and 171 are all represented by straight lines. In other implementations, the visual indicators can be any graphical indicator (e.g., an arrow, a dashed line, a curved line, etc.) that visually links a property editor with its corresponding feature. In certain implementations, the in-place visual property editors can be in the format of pop-up windows. In such a situation, when a user desires to configure a certain feature of the UI, the user can simply select that feature and a corresponding in-place property editor can appear in a pop-up window. As a result, visual properties associated with the feature can be modified through the pop-up property editor.

As noted above, design tool 100 allows a user to intuitively and readily recognize which property editor corresponds to which feature of the visual object 105. As an example, suppose that the user desires to modify feature 110 (which is the text of the header) of the visual object 105 by changing its font and/or its color. Looking at the second display screen 150, the user intuitively knows that property editor 155 should be used for the desired modification because visual indicator 156 visually links property editor 155 with the desired feature 110 to be modified. Additionally, suppose that the user further desires to modify feature 125 (which is the shadow of the panel) of the visual object 105 by changing its shadow distance and/or its shadow color. Using visual indicator 171, the user can specify that a shadow be displayed for the visual object 105 by clicking on the checkbox for the shadow property editor 175. Furthermore, by clicking on the color palette 176 of the shadow property editor 175, the user can specify the color of the shadow.

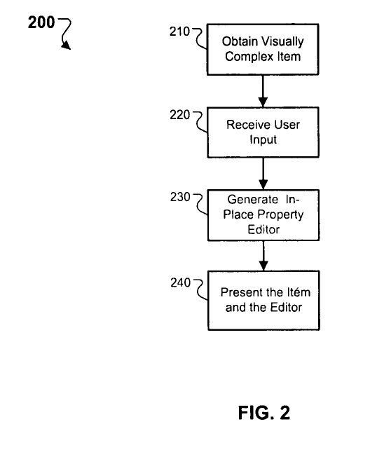

FIG. 2 is a flow chart showing an example process 200 of providing in-place property editors for configuring a visual object in a design tool. In general, the illustrated process involves obtaining one or more visual objects for configuration in a design tool. Additionally, in response to user input, the illustrated process dynamically generates in-place property editors and presents the in-place property editors simultaneously with the one or more visual objects.

In this example implementation, process 200, at 210, obtains one or more visual objects for configuration in a design tool, e.g., an interface builder software provided with Adobe® Flex® software, available from Adobe Systems Incorporated of San Jose, Calif. As noted above, the visual object can be any object in a design tool with a complex appearance and based on many different visual properties. For example, the visual object can be one of various components of a UI (e.g., panel, button, scroll bar, menu, and navigator components) or it can be a complex graphical object. Process 200 can obtain the visual objects, e.g., in response to user commands and by retrieving the visual objects from the memory of a computing device.

At 220, process 200 receives user input for generating in-place property editors. The user input can be a gesture, such as clicking on a menu bar to bring up the property editors. In one implementation, process 200 can enter a styling-focused mode where the property editors can automatically appear as the user selects a visual object in the design view. For example, in reference to FIG. 1, the user can simply click on the visual object 105 and its corresponding in-place property editors can automatically appear next to but out of the way of the object 105, as shown in the second display screen 150. In another implementation, a set of hot keys (either default keys or keys predefined by the user) can be used as the user input for process 200.

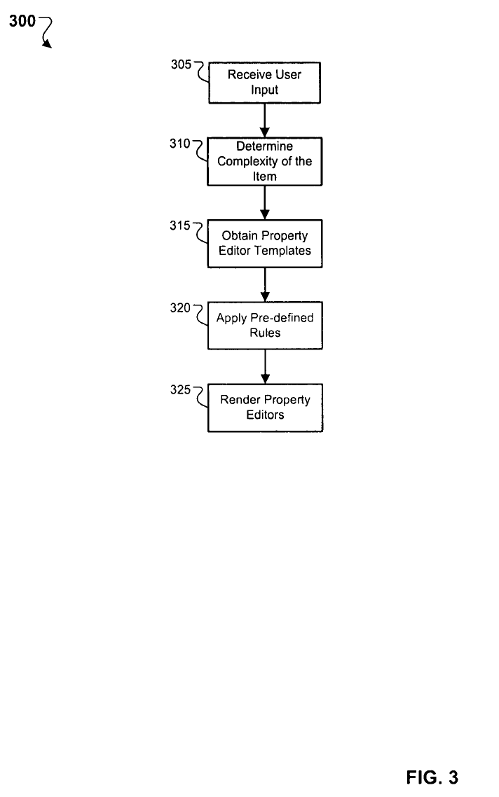

At 230, the in-place property editors associated with a visual object are generated dynamically by process 200. As will be discussed in further detail below in FIG. 3, the in-place property editor to be generated by process 200 can depend on the complexity (e.g., the number of features and the number of visual properties associated with each feature) of the visual object and the position and size of the object in the design view. In this manner, the dynamically generated in-place property editors are different from a UI that appears directly at the point of selection in a document for making quick edits to the selection. This is because such pop-up UI associated with a text selection in a document is more like a toolbar and not dynamically generated. Additionally, there is no visual indicator to directly indicate which parts of the UI affect which parts of the text selection.

Furthermore, the dynamically generated in-place property editors are different from a UI that provides configuration for products (e.g. a shoe configurator that has color swatches around the shoe pointing to different parts of the shoe). This is because such product configurator is typically not dynamically generated (e.g., does not change or re-layout over time) and is typically used to configure a single product. In contrast, the in-place property editors can apply to any number of objects in a design view and different property editors can be dynamically generated for different types of objects. Additionally the in-place property editors can dynamically reposition themselves to maintain visual linkage with the size and position of the selected object. Furthermore, the objects being configured can be dynamically created and positioned by the user, and may be of many different types, with a set of property editors associated with each, instead of being one specific type of object as in the product configurator that is typically previewed and configured in the same way.

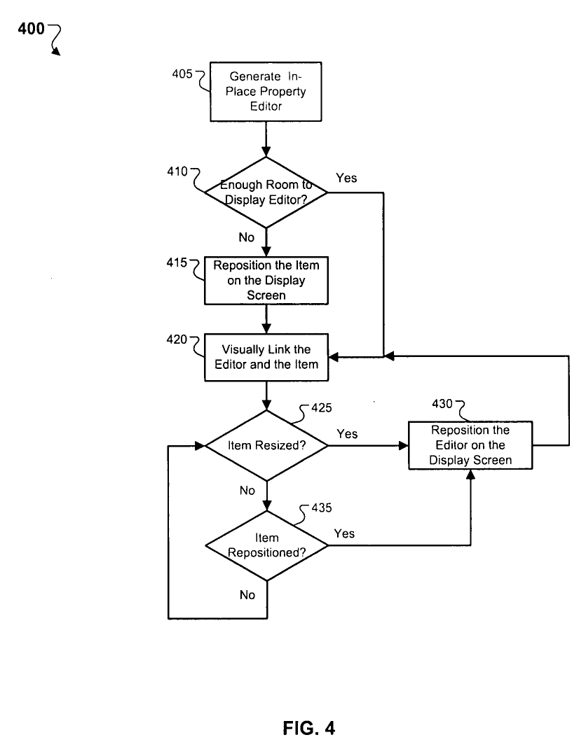

At 240, the in-place property editors associated with a visual object are presented simultaneously with the object in the design view by process 200. As will be discussed in further detail below in connection with FIG. 4, the visual object can automatically reposition itself to allow the presentation of in-place property editors, and the in-place property editors can dynamically reposition themselves to fit the size and position of the selected visual object.

FIG. 3 is a flow chart illustrating a process 300 of generating in-place property editors associated with a visual object. Such a process can be employed, for example, after receiving user input, as explained with respect to FIG. 2. In general, the illustrated process involves determining the complexity (e.g., the number of features and the number of visual properties associated with each feature) of the visual object and rendering in-place property editors by applying predefined rules to a set of property editor templates.

In this example implementation, at 305, process 300 receives user input for configuring a visual object in a design tool. As noted above, the user input can be a gesture, such as clicking on a menu bar to bring up the property editors. In one implementation, process 300 can enter a styling-focused mode where the property editors can automatically appear as the user selects a visual object in the design view. For example, in reference to FIG. 1, the user can simply click on the visual complex object 105 in the first display screen 140 and its corresponding in-place property editors can automatically appear right next to the object 105, as shown in the second display screen 150. In another implementation, a set of hot keys (either default keys or keys predefined by the user) can be used as the user input for process 300.

At 310, process 300 determines the complexity of the visual object. For example, the complexity can be determined based on the number of features and the number of visual properties associated with each feature for the visual object. For example, when building components for a UI, the radio button component can be less complex than the panel component because there can be far more features associated with the panel component in a UI. As a result, fewer in-place property editors would need to be generated for a less complex visual object, such as the radio button component of a UI. In one implementation, process 300 can determine the kind of visual object selected for configuration by a user. For instance, in reference to FIG. 1, when a user selects the visual object 105 in the first display screen 140, process 300 can determine that the visual object 105 is a panel component of a UI, which can have multiple features associated with it. Additionally, in the context of a design tool like Flex Builder, each visual object selected by the user refers to a specific instance of a UI component. This instance can contain information about the type of the component and the properties it supports.

At 315, process 300 obtains the property editor templates associated with the selected visual object. For example, suppose that the selected visual object is a radio button component of a UI. The property editor templates for the radio button component can be associated with features of the component, such as fill color of the button, and the font, size, and color of the text. In this manner, the property editor templates can specify the contents of each control group and their positioning relative to the control; for example, as offsets from various edges of the control or one of its subparts.

For example, when the selected visual object is a panel component, the header text control group can be positioned at a specific offset from the top and left edges of the header label within the panel, while the border/shadow controls can be positioned offset from the right edge of the panel and vertically centered with respect to the panel. In certain implementations, the property editor templates can be specified using a declarative mechanism (e.g. an XML-based file format), which can make it easier to add templates for different kinds of components. As a result, the declarative specification can be similar to existing declarative UI description formats, with the exception that the positioning of controls can be described relative to features of the visual object being configured.

At 320, process 300 applies predefined rules for grouping one or more visual properties associated with a feature of the visual object. In this manner, visual properties associated with a single feature of the visual object can be logically grouped together in the in-place property editor. For example, the predefined rules may specify that for a simple radio button component, the controls for font, size, and color of the text associated with the radio button component should be grouped together in one in-place property editor. As a result, the in-place property editor can be visually linked with the text of the radio button component, and a user can intuitively recognize that visual properties associated with the text can be modified through the in-place property editor.

At 325, process 300 dynamically renders the in-place property editors associated with the user selected visual object. As noted above, the property editor templates can specify the contents of each control group and their positioning relative to the control; for example, as offsets from various edges of the control or one of its subparts. For example, when the selected visual object is a panel component, the header text control group can be positioned at a specific offset from the top and left edges of the header label within the panel, while the border/shadow controls can be positioned offset from the right edge of the panel and vertically centered with respect to the panel.

FIG. 4 is a flow chart illustrating a process 400 of presenting in-place property editors associated with a visual object. Such a process can be employed, for example, after the dynamic generation of the in-place property editors, as explained with respect to FIG. 2. In general, the illustrated process involves determining the location of the visual object in a design view (e.g., on a display screen) and automatically repositioning the visual object so that in-place property editors can be simultaneously presented with the object. Additionally, the illustrated process involves determining whether the position or the size of the visual object has changed in the design view and automatically repositioning the in-place property editors to maintain the visual linkage with the visual object.

In this example implementation, at 405, process 400 generates one or more in-place property editors. As described above in more detail in FIG. 3, the in-place property editor to be generated by process 400 can depend on the complexity (e.g., the number of features and the number of visual properties associated with each feature) of the visual object and the position and size of the object in the design view.

At 410, process 400 determines if there is enough room in the design view to display the in-place property editors. For example, process 400 can examine the position/location of the visual object in the design view and determine a “distance from the edge”, which is the distance (e.g., the number of pixels) that the visual object is away from the edges of the design view. Additionally, process 400 can compare the distance from the edge to a “predetermined distance”, which is the minimum amount of distance required for presenting the in-place property editors. In this manner, if the distance from the edge of the design view is greater than the predetermined distance, then process 400 can determine that there is enough room to display the in-place property editors. In certain implementations, process 400 can determine whether there is enough room to display the property editors based on the distance from the edges of the display screen, rather than the edges of the design view. For example, the same kind of calculation as described above, but relative to the screen edges, not the edges of the design view, can be used as long as the property editors fit on the display screen.

If there is not enough room to display the in-place property editors, at 415, process 400 automatically repositions the visual object on the display screen (e.g., by auto-scrolling the entire design view) so that the in-place property editors can be displayed alongside the object in the design view. For example, in reference to FIG. 1, the visual object 105 was initially displayed near the upper left hand corner of the first display screen 140. Process 400 can examine the position of the visual object 105 and determine that there would not be enough room in the first display screen 140 to display the in-place property editors above the visual object 105. Therefore, prior to presenting the in-place property editors on the second display screen 150, process 400 can automatically reposition the visual object 105 by, e.g., moving it towards the bottom of the display screen so that the in-place property editors 155, 160, and 165 can be displayed above the visual object.

If, on the other hand, process 400, at 410, determines that there is enough room to display the in-place property editors on the display screen, process 400 proceeds to 420. At 420, process 400 visually links the in-place property editors with the visual object using visual indicators. As described above, the visual indicator can be any graphical indicator (e.g., an arrow, a straight line, a dashed line, a curved line, etc.) that visually links a property editor with its corresponding feature of the visual object.

For example, in reference to FIG. 1, visual indicator 156 links the property editor 155 (which has property controls for font, color, and size of the text) with the feature 110 (the text of the header) of the visual object 105. In one implementations, the position and orientation of the visual indicators can be specified as part of the property editor templates described above. In another implementation, the position and orientation of the visual indicators can be programmatically determined, e.g., by specifying that the visual indicator link to the center of the closest edge of a given property group to the center of the nearby edge of the corresponding feature.

In this manner, the visual indicator allows a user to intuitively and readily recognize which property editor corresponds to which feature of a visual object. As an example, suppose that the user desires to modify feature 110 (which is the text of the header) of the visual object 105 by changing its font and/or its color. Looking at the display screen 150, the user can intuitively recognize that property editor 155 should be used for the desired modification because visual indicator 156 links property editor 155 with the desired feature 110 to be modified.

Referring back to FIG. 1, the in-place property editors are presented proximate to (e.g., alongside or right next to) the visual object 105 in the second display screen 150. However, in certain implementations, the in-place property editors may not be presented proximate to the visual object. For example, the in-place property editors can be displayed on top of the visual object, so long as the property editors do not obscure their corresponding features of the object. Additionally, the property editors can be placed in a single area off to the side of the entire design view, e.g., in a sidebar or margin, yet still maintain the visual linkage to the corresponding visual object, in order to avoid obscuring other nearby visual objects.

At 425, process 400 determines whether the visual object has been resized. For example, during the process of building a UI in a design tool, the user may change the size of a component of the UI (e.g., the panel or the button component). Process 400 can examine the display screen and determine whether the visual object has been reduced or enlarged in size. If the visual object has been resized, at 430, process 400 can automatically reposition the in-place property editors on the display screen and maintain the visual linkage between the in-place property editors and their corresponding features out the visual object. Additionally, after repositioning the in-place property editors on the display screen, process 400 proceeds to 420 and visually links the repositioned property editors with the resized visual object.

At 435, process 400 determines whether the visual object has been repositioned. For example, during the process of building a UI in a design tool, the user may reposition a component of the UI (e.g., the panel or the button component). Process 400 can examine the display screen and determine whether the location of the visual object has been changed. If the visual object has been repositioned, at 430, process 400 can automatically reposition the in-place property editors on the display screen and maintain the visual linkage between the in-place property editors and their corresponding features of the visual object. Additionally, after repositioning the in-place property editors on the display screen, process 400 proceeds to 420 and visually links the repositioned property editors with the repositioned visual object.

On the other hand, if the visual object has not been repositioned, process 400 iterates back to 425 and determines whether the visual object has been resized. In this manner, process 400 can dynamically determine whether the visual object has been resized or repositioned on the display screen, and automatically reposition the in-place property editors.

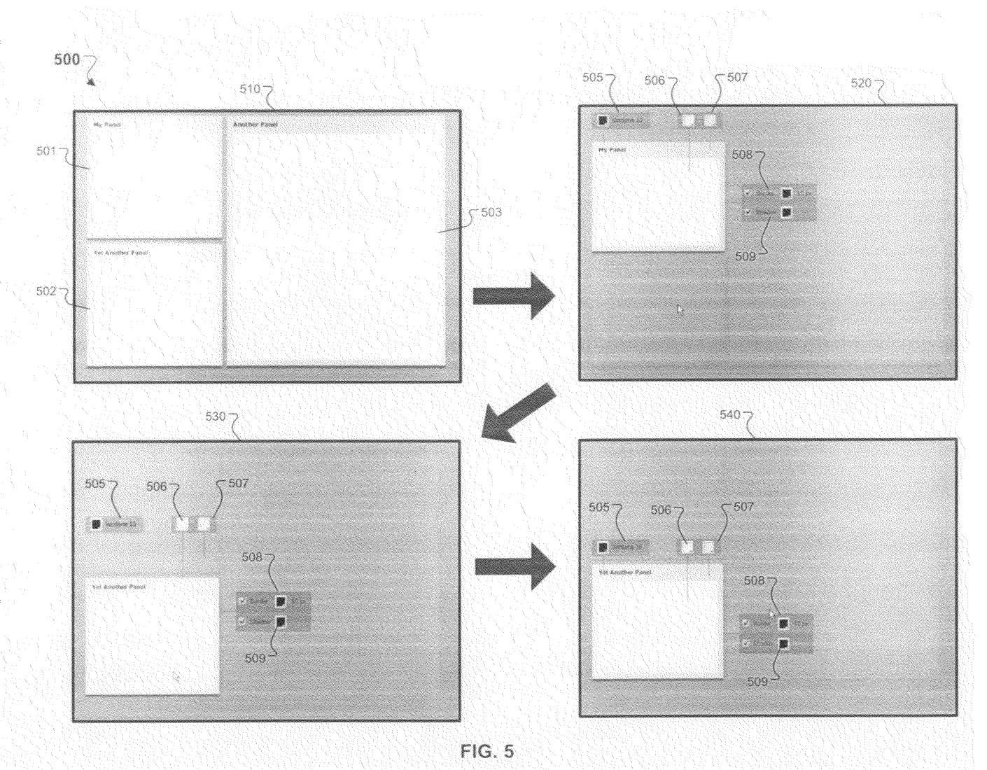

FIG. 5 shows example design views 510, 520, 530, and 540 illustrating multiple visual objects and a set of in-place property editors associated with one or more of the visual objects. In general, as described above, when a user selects a visual object (or explicitly requests the property editor) in a design view, one or more property editors specific to the type of the selected object can be dynamically generated and presented simultaneously with the selected object in the design view. Individual controls in the property editors can be positioned relative to the appropriate feature of the selected object. For example, a property editor relevant to the border of the object can be placed on one side of the object, and a visual indicator (e.g., a line) can be drawn from the property editor to the border. In this manner, the visual indicator can link individual property editors to the appropriate corresponding features of the selected object.

In this example implementation, system 500 presents a first design view 510 that includes three visual objects: visual object 501, visual object 502, and visual object 503. As shown, all three visual objects represent the panel component of a UI; however, in other implementations, different components of a UI or non-UI based visual objects (e.g., a complex graphical object) can be used. Suppose that a user desires to modify the visual properties of the visual object 501. The user can select object 501 for configuration, e.g., by directly clicking on object 501.

In response to the user input, system 500 can dynamically generate in-place property editors corresponding to the selected visual object 501. For example, system 500 can generate a property editor 505 associated with the text of the header for the object 501. System 500 can also generate other property editors, such as property editor 506 associated with the background of the object 501, property editor 507 associated with the header of the object 501, property editor 508 associated with the border of the object 501, and property editor 509 associated with the shadow of the object 501. The second display screen 520 presents the dynamically generated in-place property editors simultaneously with the selected visual object 501.

As shown in the second design view 520, in response to the user input, system 500 can automatically focus on the selected visual object 501. In one implementation, when a user selects visual object 501 for configuration, system 500 can automatically fade out the other visual objects 502, and 503, yet still make them partially visible, (e.g., by “graying out”) from the display screen. Additionally, as described in more detail above, system 500 can automatically reposition (e.g., by auto-scrolling) the selected visual object 501, e.g., by moving it towards the bottom of the display screen 520. In this manner, the in-place property editors 505, 506, and 507 can be presented above the visual complex object 501 simultaneously with the object 501.

As noted above, even though visual objects 502 and 503 have been faded out, a user can still see them because of the partial transparency in the design view. For example, after completing the configuration of visual object 501, the user can then select object 502 for configuration, e.g., by directly clicking on object 502. In response to this new user input, system 500 can dynamically generate in-place property editors corresponding to the selected visual object 502, similar to what has been described for visual object 501. In certain implementations, however, system 500 can simply move the property editors 505, 506, 507, 508, and 509 from being proximate to visual object 501 to being proximate to visual object 502.

For example, the third design view 530 shows that the set of property editors associated with visual object 501 being “snapped” over to visual object 502, when the user selects visual object 502 for configuration. Furthermore, as shown in the fourth display screen 540, in response to the user input, system 500 can also automatically focus on the selected visual object 502. As a result, visual objects 501 and 503 are faded out by system 500 and property editors 505, 506, 507, 508, and 509 now appear proximate to visual object 502, with the visual indicators linking the property editors to their corresponding features of object 502.

In this manner, when one or more visual objects of the same kind (e.g., objects 501, 502, and 503 are all panel components of a UI) are presented in the same design view, system 500 can readily move the set of property editors from one object to the next in response to user selection, without having to dynamically generate the property editors. Additionally, even when different visual objects are presented in the same design view (e.g., a button component and a combo-box component of a UI), if those visual objects share one or more property editors, system 500 can also move the property editors that are common to the visual objects from one object to the next, in response to user selection. Furthermore, system 500 can dynamically generate those property editors that are not common to the visual objects.

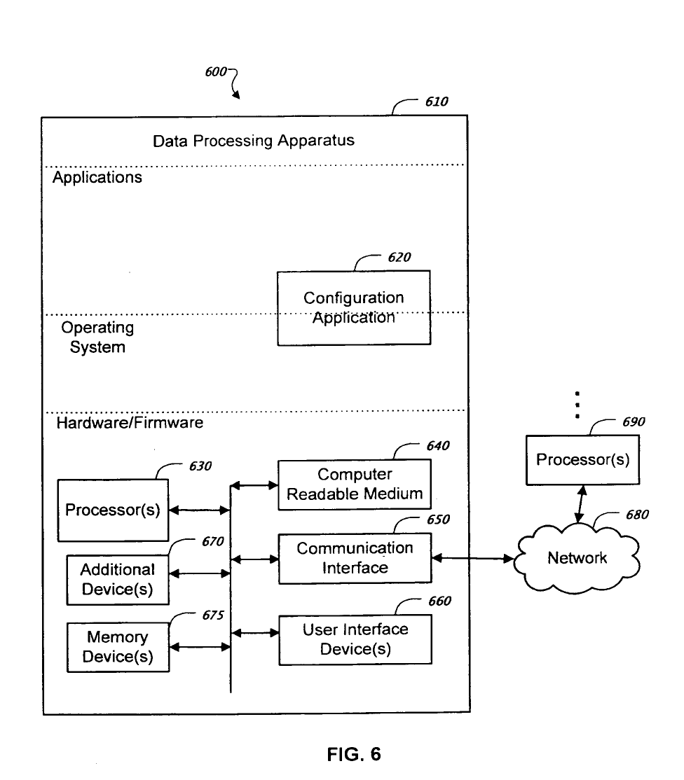

FIG. 6 shows an example system 600 configured to allow a user to configure visual objects in an authoring tool by generating and presenting in-place property editors for configuring the visual objects. A data processing apparatus 610 can include hardware/firmware, an operating system and one or more applications, including a configuration application 620. The configuration application 620 can include, for example, a design tool for configuring UIs. As used herein, an application refers to a computer program that the user perceives as a distinct computer tool used for a defined purpose. The configuration application 620 can be built entirely into the operating system (OS) of the data processing apparatus 610, or the configuration application 620 can have different components located in different locations (e.g., one portion in the OS or kernel mode, one portion in the user mode, and one portion in a remote server), and the configuration 620 can be built on a runtime library serving as a software platform of the apparatus 610. Moreover, the configuration application 620 can be a graphical user interface application (e.g., a Web browser) that connects to one or more processors 690 (e.g., one or more Web servers) over a network 680 and provides the computer tool as a network service.

The configuration application 620 can include, e.g., interface builder software (e.g., Adobe® Flex® software, available from Adobe Systems Incorporated of San Jose, Calif.), animation software (e.g., Adobe® Flash® software, available from Adobe Systems Incorporated of San Jose, Calif.), visual effects software (e.g., Adobe® After Effects® software, available from Adobe Systems Incorporated of San Jose, Calif.), image editing software (e.g., Adobe® Photoshop® software, available from Adobe Systems Incorporated of San Jose, Calif.), and video editing software (e.g., Adobe® Premiere® software, available from Adobe Systems Incorporated of San Jose, Calif.). Thus, the configuration application 620 can operate on different types of objects from many different sources.

The data processing apparatus 610 includes one or more processors 630 and at least one computer-readable medium 640. The data processing apparatus 610 can also include a communication interface 650, one or more user interface devices 660, and one or more additional devices 670 and memory devices 675. The user interface device(s) 660 can include display screen(s), keyboard(s) (e.g., a custom video editing keyboard), mouse, stylus, or any combination thereof. Moreover, the data processing apparatus 610 can itself be considered a user interface device (e.g., when the configuration application 620 is delivered as a Web service).

The additional device(s) 670 can include various devices used for video and film editing. This can include a video controller coupled to a video recorder (which can be used for storing and importing video footage and for writing final output), a sound system, and a battery backup. Moreover, the subject matter described in this specification can be used in conjunction with any digital print engine or marking engine, display monitor, or other raster output device capable of producing color or gray scale pixels on paper, film, display screen, or other output medium. Memory device 675 can be a form of random access memory (RAM) such as a dynamic random access memory (DRAM), flash memory, synchronous dynamic random access memory (SDRAM), or other removable storage device. Once properly programmed, the data processing apparatus 610 is operable to allow a user to author animation effects in an animation by specifying at least one frame of the key frames and generate an animation sequence dynamically at runtime.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, how the user chooses to bring up the in-place property editors or enters the styling-focused mode in which the in-place property editors appear automatically can be varied. Additionally, an extensible way to dynamically generate in-place property editors for new visual objects can be provided. In other implementations, the in-place property editors can be extended to editing desktop windows in a computing device. For example, a user can select a real window on her desktop, choose a menu such as “Edit Window Style”, and have an in-place property editor for configuring the header color pop up above the desktop window and an in-place property editor for configuring the border color pop up to the right of the desktop window. Accordingly, other implementations are within the scope of the following claims.

What is claimed is:

1. A computer-implemented method comprising:
receiving user input to access a property editor associated with at least one feature of a visual object, the visual object being a graphical object and the feature being a sub-portion of the visual object;
dynamically generating, in response to the user input, the property editor based, at least in part, on a complexity of the visual object; and
presenting the visual object and the property editor on a display screen along with a visual indicator extending from at least one aspect of the property editor to the at least one feature of the visual object.

2. The method of claim 1, further comprising:
dynamically generating a plurality of additional property editors in response to the user input, the plurality of additional property editors being associated with a plurality of additional features of the visual object; and
presenting the visual object and the plurality of additional property editors on a display screen along with a visual indicator extending from each of the plurality of property editors to at least one of the plurality of features of the visual object.

3. The method of claim 1, further comprising:
obtaining the visual object in an authoring tool,

4. The method of claim 1, wherein the user input comprises one or more of the following: pressing a hot key, selecting an edit tool from a menu, or selecting the visual object.

5. The method of claim 1, wherein presenting the visual object and the property editor on the display screen comprises:
automatically repositioning a design view of the visual object on the display screen to make room for the property editor on the display screen.

6. The method of claim 1, wherein presenting the visual object and the property editor on the display screen further comprises:
automatically focusing on the visual object by fading out other objects on the display screen.

7. The method of claim 1, wherein presenting the visual object and the property editor on the display screen further comprises:
automatically repositioning the property editor in response to a change in size or position of the visual object on the display screen.

8. The method of claim 1, wherein the visual object comprises a component of a user interface.

9. The method of claim 8, wherein the at least one feature is a feature of the component of the user interface selected from a group comprising of a header, a button, a border, a shadow, a text of the header, and a corner.

10. The method of claim 1, wherein the property editor is displayed proximate to but out of the way of the visual object.

11. The method of claim 1, wherein the at least one feature comprises at least one visual property for a graphics object configurable through the property editor.

12. The method of claim 11, wherein the at least one visual property comprises one or more of the following: color, font, text alignment, size, layout, and opacity.

13. The method of claim 11, further comprising:
receiving a second user input to modify the at least one visual property through the property editor; and.
presenting a modified feature in response to the second user input and based on the modified visual property.

14. The method of claim 1, wherein the visual indicator comprises a straight line, a dashed line, a curved line, or an arrow.

15. A computer program product, encoded on a non-transitory computer-readable medium, operable to cause data processing apparatus to perform operations comprising:
receiving user input to access a property editor associated with at least one feature of a visual object;
dynamically generating, in response to the user input, the property editor based, at least in part, on a complexity of the visual object; and
presenting the visual object and the property editor on a display screen along with a visual indicator extending from at least one aspect of the property editor to the at least one feature of the visual object.

16. The computer program product of claim 15, wherein the operations further comprise:
dynamically generating a plurality of additional property editors in response to the user input, the plurality of additional property editors being associated with a plurality of additional features of the visual object; and
presenting the visual object and the plurality of additional property editors on a display screen along with a visual indicator extending from each of the plurality of property editors to at least one of the plurality of features of the visual object,

17. The computer program product of claim 15, wherein the operations further comprise:
obtaining the visual object in an authoring tool.

18. The computer program product of claim 15, wherein the user input comprises one or more of the following: pressing a hot key, selecting an edit tool from a menu, or selecting the visual object.

19. The computer program product of claim 15, wherein presenting the visual object and the property editor on the display screen comprises:
automatically repositioning a design view of the visual object on the display screen to make room for the property editor on the display screen.

20. The computer program product of claim 15, wherein presenting the visual object and the property editor on the display screen further comprises:
automatically focusing on the visual object by fading out other objects on the display screen.

21. The computer program product of claim 15, wherein presenting the visual object and the property editor on the display screen further comprises:
automatically repositioning the property editor in response to a change in size or position of the visual object on the display screen.

22. The computer program product of claim 15, wherein the visual object comprises a component of a user interface.

23. The computer program product of claim 22, wherein the at least one feature is a feature of the component of the user interface selected from a group comprising of a header, a button, a border, a shadow, a text of the header, and a corner.

24. The computer program product of claim 15, wherein the property editor is displayed proximate to but out of the way of the visual object.

25. The computer program product of claim 15, wherein the at least one feature comprises at least one visual property for a graphics object configurable through the property editor.

26. The computer program product of claim 25, wherein the at least one visual property comprises one or more of the following: color, font, text alignment, size, layout, and opacity.

27. The computer program product of claim 25, further comprising:
receiving a second user input to modify the at least one visual property through the property editor; and
presenting a modified feature in response to the second user input and based on the modified visual property.

28. The computer program product of claim 15, wherein the visual indicator comprises a straight line, a dashed line, a curved line, or an arrow.

29. A system comprising:
a user interface device; and
one or more computers operable to interact with the user interface device and to perform operations comprising:
receiving user input to access a property editor associated with at east one feature of a visual object;
dynamically generating, in response to the user input, the property editor based, at least in part, on a complexity of the visual object; and
presenting the visual object and the property editor on a display screen along with a visual indicator extending from at least one aspect of the property editor to the at least one feature of the visual object,

30. The system of claim 29, wherein the operations further comprise:
dynamically generating a plurality of additional property editors in response to the user input, the plurality of additional property editors being associated with a plurality of additional features of the visual object; and
presenting the visual object and the plurality of additional property editors on a display screen along with a visual indicator extending from each of the plurality of property editors to at least one of the plurality of features of the visual object,

31. The system of claim 29, wherein the operations further comprise:
obtaining the visual object in an authoring tool.

32. The system of claim 29, wherein the user input comprises one or more of the following: pressing a hot key, selecting an edit tool from a menu, or selecting the visual object.

33. The system of claim 29, wherein presenting the visual object and he property editor on the display screen comprises:
automatically repositioning a design view of the visual object on the display screen to make room for the property editor on the display screen.

34. The system of claim 29, wherein presenting the visual object and the property editor on the display screen further comprises:
automatically focusing on the visual object by fading out other objects on the display screen.

35. The system of claim 29, wherein presenting the visual object and the property editor on the display screen further comprises:
automatically repositioning the property editor in response to a change in size or position of the visual object on the display screen.

36. The system of claim 29, wherein the visual object comprises a component of a user interface.

37. The system of claim 36, wherein the at least one feature is a feature of the component of the user interface selected from a group comprising of a header, a button, a border, a shadow, a text of the header, and a corner.

38. The system of claim 29, wherein the property editor is displayed proximate to but out of the way of the visual object.

39. The system of claim 29, wherein the at least one feature comprises at least one visual property for a graphics object configurable through the property editor.

40. The system of claim 39, wherein the at least one visual property comprises one or more of the following: color, font, text alignment, size, layout, and opacity.

41. The system of claim 39, further comprising:
receiving a second user input to modify the at least one visual property through the property editor; and
presenting a modified feature in response to the second user input and based on the modified visual property.

42. The system of claim 29, wherein the visual indicator comprises a straight line, a dashed line, a curved line, or an arrow.

43. The computer-implemented method of claim 1, further comprising determining the complexity of the visual object.

44. The computer-implemented method of claim 43, further comprising:
obtaining a property editor template associated with the visual object;
wherein presenting the visual object and the property editor on a display screen is based, at least in part, on the property editor template.

45. The computer-implemented method of claim 44, wherein the feature comprises one or more visual properties and wherein presenting the visual object and the property editor is based on a predefined rule for grouping the one or more visual properties.

46. The computer-implemented method of claim 43, wherein the feature comprises one or more visual properties and wherein presenting the visual object and the property editor is based on a predefined rule for grouping the one or more visual properties.

47. The computer program product of claim 15, further comprising determining the complexity of the visual object.

48. The computer program product of claim 47, further comprising:
obtaining a property editor template associated with the visual object;
wherein presenting the visual object and the property editor on a display screen is based, at least in part, on the property editor template.

49. The computer program product of claim 48, wherein the feature comprises one or more visual properties and wherein presenting the visual object and the property editor is based on a predefined rule for grouping the one or more visual properties.

50. The computer program product of claim 47, wherein the feature comprises one or more visual properties and wherein presenting the visual object and the property editor is based on a predefined rule for grouping the one or more visual properties.

51. The system of claim 29, wherein the one or more computers are further configured to perform an operation comprising determining the complexity of the visual object.

52. The system of claim 51, wherein the one or more computers are further configured to perform an operation comprising:
obtaining a property editor template associated with the visual object;
wherein presenting the visual object and the property editor on a display screen is based, at least in part, on the property editor template.

53. The system claim 52, wherein the feature comprises one or more visual properties and wherein presenting the visual object and the property editor is based on a predefined rule for grouping the one or more visual properties.

54. The system of claim 511, wherein the feature comprises one or more visual properties and wherein presenting the visual object and the property editor is based on a predefined rule for grouping the one or more visual properties.
